(19) United States
(12) Patent Application Publication
(10) Pub. No.: US 2025/0292340 A1
(43) Pub. Date: Sep. 18, 2025

(54) RECIPE OPTIMIZATION FOR FOOD APPLICATIONS

(71) Applicant: Clara Foods Co., Daly City, CA (US)

(72) Inventors: A Samuel POTTINGER, Daly City, CA (US); Ying Joy ZHONG, Fremont, CA (US); Andrew Keum Min MIYASHIRO, Foster City, CA (US)

(73) Assignee: Clara Foods Co., Daly City, CA (US)

(21) Appl. No.: 19/221,415

(22) Filed: May 28, 2025

Related U.S. Application Data
(63) Continuation of application No. PCT/US2023/081691, filed on Nov. 29, 2023.
(60) Provisional application No. 63/385,233, filed on Nov. 29, 2022.

(51) Int. Cl. G06Q 50/12; G06N 20/00

(52) U.S. Cl. CPC G06Q 50/12; G06N 20/00

(57) ABSTRACT

The present disclosure provides methods and systems for recipe optimization for food applications. A recipe optimization system generates a seed dataset comprising an initial randomized set of seed recipes based on a list of starting ingredients. The recipe optimization system obtains feedback data for a plurality of food products made using the initial randomized set of seed recipes during an initial experimental run. The recipe optimization system generates a plurality of candidate recipes based at least on (1) the feedback data and (2) one or more recipe constraints. The recipe optimization systems applies a predictive model to rank the plurality of candidate recipes according and selects one or more top-ranked candidate recipes for one or more subsequent experimental runs to further optimize the objective function.

### CROSS-REFERENCE TO RELATED APPLICATIONS

This application is a continuation of International Application No. PCT/US2023/081691, filed on Nov. 29, 2023, which claims the benefit of U.S. Provisional Application No. 63/385,233, filed on Nov. 29, 2022, the disclosures of which are incorporated herein by reference in their entirety.

### BACKGROUND

Advances in modern chemistry and biological sciences have reduced the need for factory farming and carbon intensive food production synthesizing biological products for wide-ranging food applications including, for example, plant-based eggs, lab-grown meat, improved baking yeast, and nutritional supplements. However, in some instances, combining ingredients the same way (e.g., same ingredients, same recipe) in a synthesized product may not lead to the same results that would be obtained from a naturally occurring product. Techniques for recipe optimization are therefore needed to generate a food product that shares at least a similar nutritional profile and/or other attributes, for instance, taste, texture, appearance. However, conventional approaches for recipe optimization generally require extensive characterization and experimental resources, which may involve exhaustive testing of multiple ingredients at different levels to determine an ideal combination of ingredients.

### SUMMARY

Provided herein are methods and systems for rapid recipe optimization for food application. The methods and systems described herein can accelerate recipe optimization without requiring extensive prior characterization of ingredients.

In an aspect, the present disclosure provides a method for recipe optimization for food applications, comprising: (a) generating a seed dataset comprising an initial randomized set of seed recipes based on a list of starting ingredients; (b) obtaining feedback data for a plurality of food products made using the initial randomized set of seed recipes during an initial experimental run, wherein the feedback data comprises a plurality of scores and comments on a plurality of attributes for each food product; (c) generating a plurality of candidate recipes based at least on (1) the feedback data and (2) one or more recipe constraints, wherein each candidate recipe is represented as a vector comprising a plurality of elements that correspond to one or more ingredients from the starting list of ingredients; (d) applying a predictive model to rank the plurality of candidate recipes, wherein the predictive model comprises an objective function that generates a score for each candidate recipe based at least on (1) likeability for each individual attribute, (2) overall likeability, or (3) similarity to a control sample; and (e) selecting one or more top-ranked candidate recipes for one or more subsequent experimental runs to further optimize the objective function.

In some embodiments of any one of the methods disclosed herein, the seed dataset comprises about 10 to 20 seed recipes. In some embodiments of any one of the methods disclosed herein, the seed dataset comprises no more than about 20 seed recipes.

In some embodiments of any one of the methods disclosed herein, the plurality of attributes comprise flavor, texture, mouth feel, taste, odor or appearance. In some embodiments of any one of the methods disclosed herein, the plurality of attributes relate to cooking functionality including gelation, foaming or baking.

In some embodiments of any one of the methods disclosed herein, the recipe optimization is performed on one or more new ingredients that are previously unknown or have yet to be characterized. In some embodiments of any one of the methods disclosed herein, the recipe optimization is performed without requiring substantial or detailed prior characterization of the starting list of ingredients or one or more new ingredients.

In some embodiments of any one of the methods disclosed herein, the feedback data is generated or provided by a panel of human raters. In some embodiments of any one of the methods disclosed herein, the comments comprise free-form text from the panel of human raters.

In some embodiments of any one of the methods disclosed herein, the control sample comprises a naturally occurring product. In some embodiments of any one of the methods disclosed herein, the naturally occurring product comprises a whole hen's egg. In some embodiments of any one of the methods disclosed herein, the control sample is unseasoned. In some embodiments of any one of the methods disclosed herein, the control sample is seasoned.

In some embodiments of any one of the methods disclosed herein, wherein (b) further comprises normalizing the plurality of scores and (c) further comprises generating the plurality of candidate recipes based at least on the normalized scores.

In some embodiments of any one of the methods disclosed herein, the plurality of candidate recipes comprise at least 10,000 candidate recipes. In some embodiments of any one of the methods disclosed herein, the plurality of candidate recipes comprise at least 100,000 candidate recipes.

In some embodiments of any one of the methods disclosed herein, the optimal predictive model is selected from among the plurality of machine-learning models by performing a sweep across multiple machine-learning models to identify a model that has a lowest median absolute error (MdAE) on a validation dataset.

In some embodiments of any one of the methods disclosed herein, the plurality of machine-learning models comprise one or more linear or regression models. In some embodiments of any one of the methods disclosed herein, the plurality of machine-learning models comprise adaboost, random forest, decision tree, support vector, or a neural network.

In some embodiments of any one of the methods disclosed herein, the model selector comprises a grid search algorithm, and the selected optimal predictive model comprises a neural network.

In some embodiments of any one of the methods disclosed herein, the plurality of machine-learning models comprise a natural language processing (NLP) model. In some embodiments of any one of the methods disclosed herein, the NLP model processes the comments in the feedback data. In some embodiments of any one of the methods disclosed herein, the objective function comprises one or more NLP-derived metrics.

In some embodiments of any one of the methods disclosed herein, the selected optimal predictive model predicts individual contributions or effects of each ingredient, as well as its interactions with other ingredients, to or on the plurality of attributes. In some embodiments of any one of the methods disclosed herein, the interactions comprise non-linearities or non-linear behavior or characteristics.

In some embodiments of any one of the methods disclosed herein, the initial and the one or more subsequent experimental runs are run over a period of multiple days, weeks or months.

In some embodiments of any one of the methods disclosed herein, the one or more subsequent experimental runs comprise one or more modifications to one or more prior candidate recipes.

In some embodiments of any one of the methods disclosed herein, the one or more recipe constraints comprise a threshold amount of the one or more of ingredients within the food product. In some embodiments of any one of the methods disclosed herein, the one or more recipe constraints comprise a maximum amount of lipids and proteins.

In some embodiments of any one of the methods disclosed herein, the vector for each candidate recipe comprises a floating-point vector such that ingredients in the candidate recipe add up to 100%.

In some embodiments of any one of the methods disclosed herein, the objective function maximizes predicted scores for at least one of (1) likeability for each individual attribute, (2) overall likeability, or (3) similarity to the control sample.

In some embodiments of any one of the methods disclosed herein, the recipe optimization employs an exploration and exploitation technique. In some embodiments of any one of the methods disclosed herein, (c) and (d) correspond to an exploration phase of the recipe optimization, and (e) and (f) correspond to an exploitation phase of the recipe optimization. In some embodiments of any one of the methods disclosed herein, the exploration phase and the exploitation phase are each adjustable for an n^{th} experimental run, wherein n is an integer greater than 2. In some embodiments of any one of the methods disclosed herein, a number of candidate exploration recipes or samples used in the exploration phase and a number of candidate exploitation recipes or samples used in the exploitation phase are each adjustable from 0% to 100% relative to each other in each experimental run.

In some embodiments of any one of the methods disclosed herein, the model selector is trained and retrained by grid sweeping across the multiple machine-learning models for each experimental run. In some embodiments of any one of the methods disclosed herein, data from each experimental run is divided into a training dataset, a validation dataset, and a test dataset. In some embodiments of any one of the methods disclosed herein, the training dataset comprises 50% to 98% of the data, the validation dataset comprises 1% to 25% of the data, and the training dataset comprises 1% to 25% of the data.

In some embodiments of any one of the methods disclosed herein, the method further comprises formulating hypotheses on ingredients, recipes and food sciences based at least on (1) the one or more top-ranked candidate recipes or other newly generated top-ranked candidate recipes and (2) the feedback data.

In some embodiments of any one of the methods disclosed herein, the method further comprises: providing an interface for facilitating human-machine collaboration, wherein the interface provides graphical and numerical predictions of individual attribute levels and overall likeability levels, in response to one or more new hypotheses that are input by one or more users via the interface. In some embodiments of any one of the methods disclosed herein, the interface comprises color representations or a color scale that is indicative of the predicted individual attribute levels and/or predicted overall likeability levels.

In some embodiments of any one of the methods disclosed herein, the plurality of candidate recipes comprise two or more levels of inclusion of each ingredient.

In some embodiments of any one of the methods disclosed herein, the objective function further optimizes a nutritional profile. In some embodiments of any one of the methods disclosed herein, the objective function comprises a similarity metric of the nutritional profile based on quantification of amino acid profile against a target nutritional profile in a naturally occurring product.

In some embodiments of any one of the methods disclosed herein, the objective function further optimizes for cooking experience and appearance of the food products during their preparation.

In some embodiments of any one of the methods disclosed herein, the food product(s) comprise one or more food scrambles.

In another aspect, the present disclosure provides a system for recipe optimization for food applications using any one of the methods disclosed herein. In some embodiments of any one of the systems disclosed herein, the system comprises a computing system configured to implement the machine learning enabled method for recipe optimization. In some embodiments of any one of the methods disclosed herein, the system comprises computers, programs, mobile applications, user interface, models, algorithms, and data.

Another aspect provides a non-transitory computer readable medium comprising machine executable code that, upon execution by one or more computer processors, implements any of the methods above or elsewhere herein.

Another aspect provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein illustrative embodiments are shown and described. As will be realized, the present disclosure is capable of other and different embodiments, including modifications in various respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 is a block diagram of the system architecture of a recipe optimization system 100, in accordance with some embodiments.

FIG. 2 is a flowchart illustrating a method for optimizing candidate recipes, in accordance with some embodiments.

FIG. 3 illustrates an example user interface for designing a user interface, according to some embodiments. FIG. 3 also shows a comparison of median likeability and median similarity of starting recipes and machine learning (ML) recommended recipes, in accordance with some embodiments.

FIG. 4 is a schematic illustration of a method for optimizing candidate recipes, in accordance with some embodiments.

FIG. 5 illustrates medial similarity and median liability scores for recipes generated using raw scores and machine-learning scores, in accordance with some embodiments.

FIG. 6 illustrates a histogram of likability and similarity scores of recipes during the recipe optimization process, in accordance with some embodiments.

FIG. 7 illustrates a graph of objective function scores versus time (in weeks), in accordance with some embodiments.

FIG. 8 illustrates a comparison of subjective function scores of machine-learning recommended recipes and manual recipes, in accordance with some embodiments.

FIG. 9 illustrates a computer system 901 that is programmed or otherwise configured to optimize recipes, in accordance with some embodiments.

### DETAILED DESCRIPTION

Recognized herein is a need for methods and systems to provide automated recipe optimization for food applications. Such a method or system can significantly accelerate the recipe optimization process without requiring extensive prior characterization of ingredients and/or extensive experimentation.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

As used in the specification and claims, the singular forms “a,” “an,” and “the” can include plural references unless the context clearly dictates otherwise. For example, the term “a candidate recipe” can include a plurality of candidate recipes.

The term “about” or “approximately,” as used interchangeably herein, generally refers to within an acceptable error range for the particular value as determined by one of ordinary skill in the art, which will depend in part on how the value is measured or determined, i.e., the limitations of the measurement system. For example, “about” can mean within 1 or more than 1 standard deviation, per the practice in the art. Alternatively, “about” can mean a range of up to 20%, up to 10%, up to 5%, or up to 1% of a given value. Alternatively, particularly with respect to biological systems or processes, the term can mean within an order of magnitude, preferably within 5-fold, and more preferably within 2-fold, of a value. Where particular values are described in the application and claims, unless otherwise stated, the term “about” meaning within an acceptable error range for the particular value should be assumed.

The term “structured data,” as used herein, generally refers to quantitative data, for example, number, score, or percentage. Structured data is generally highly organized and easily decipherable by machine-learning models.

The term “unstructured data,” as used herein, generally refers to qualitative data, for example, comment, description, or text. Unstructured data can be indexed or non-indexed.

The term “free-form text,” or “comment,” as used interchangeably herein, generally refers to non-numerical word or sentence. It may be unstructured. For example, “this tastes good but will taste better if it is softer.”

The term “food product,” as used herein, generally refers to food prepared according to a recipe disclosed herein.

The term “food scramble,” as used herein, generally refers to food mixture with different ingredients. For example, an egg scramble may comprise egg white, yolk, pepper, onion, etc.

The term “recipe,” as used herein, generally refers to a list of ingredients and the composition of each ingredient. Recipe may also comprise instructions to prepare a food product using the list of ingredients.

The term “Natural language processing” or “NLP,” as used interchangeably herein, generally refers to a process used to describe an abstracted set of inputs to a text analysis engine so that it might extract concepts (named entities, like “person” references, “food product” references, etc.) and relationships between those concepts (e.g., “like”). With these “facts”, the text can be exposed for programmatic use and process automation. Examples of facts in this case would be “I think the food product smells and tastes good”.

### I. Methods and Systems for Recipe Optimization

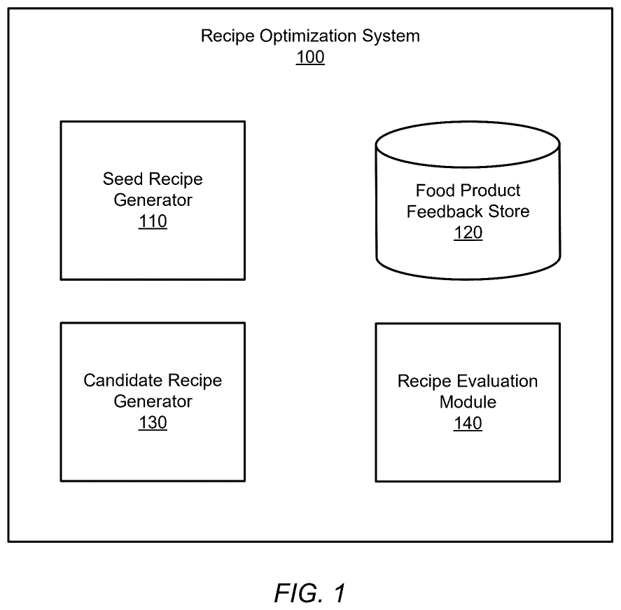

Disclosed herein are methods and systems for applying trained machine-learning model to perform recipe optimization for food applications. In an aspect, the present disclosure provides a method for recipe optimization, for example the method illustrated in FIG. 1. In another aspect, the present disclosure provides a system for recipe optimization. The system may comprise a computing system configured to implement the machine-learning enabled method for recipe optimization. The system may comprise computers, programs, mobile applications, user interface, models, algorithms, and data.

FIG. 1 is a block diagram of the system architecture of a recipe optimization system 100, in accordance with some embodiments. The recipe optimization system 100 includes a seed recipe generator 110, a food product feedback store 120, a candidate recipe generator 130, and a recipe evaluation module 140. However, in other embodiments, the recipe optimization system 100 may include different and/or additional components. In some embodiments, the recipe optimization system 100 can perform multiple simultaneous, concurrent, and continuous recipe optimization processes.

The seed recipe generator 110 generates an initial set of seed recipes based on a starting list of ingredients. As described herein, a “seed recipe” is an initial recipe randomly generated based on the starting list of ingredients. As will be described below, the recipe optimization system 120 implements various techniques to optimize the initial set of seed recipes based on one or more evaluation metrics. In some embodiments, the seed recipe generator 110 randomizes the set of seed recipes. In some embodiments, the set of seed recipes may be generated based on the ingredients and composition of a control food product. For example, a control food product, its ingredients, and composition may collected from a previously developed or accessed recipe.

In some embodiments, the seed recipe generator 110 generates an initial set of seed recipes, also referred to as a seed dataset, that includes at least 10 seed recipes, at least 20 seed recipes, at least 30 seed recipes, at least 40 seed recipes, at least 50 seed recipes, at least 60 seed recipes, at least 70 seed recipes, at least 80 seed recipes, at least 90 seed recipes, at least 100 seed recipes, or more. In some embodiments, the seed recipe generator 110 generates a seed dataset that includes at most 100 seed recipes, at most 90 seed recipes, at most 80 seed recipes, at most 70 seed recipes, at most 60 seed recipes, at most 50 seed recipes, at most 40 seed recipes, at most 30 seed recipes, at most 20 seed recipes, at most 10 seed recipes, or less. In some embodiments, the seed dataset may comprise about 10 to 20 seed recipes. In some embodiments, the seed recipe generator 110 generates a seed dataset that includes at most 20 seed recipes, at most 19 seed recipes, at most 18 seed recipes, at most 17 seed recipes, at most 16 seed recipes, at most 15 seed recipes, at most 14 seed recipes, at most 13 seed recipes, at most 12 seed recipes, at most 11 seed recipes, or less.

The seed recipe generator 110 generates the seed dataset based, at least in part, on a list of starting ingredients. In some embodiments, the list of starting ingredients includes least 5 ingredients, at least 10 ingredients, at least 20 ingredients, at least 30 ingredients, at least 40 ingredients, at least 50 ingredients, or more. In some embodiments, the list of starting ingredients may comprise at most 50 ingredients, at most 40 ingredients, at most 30 ingredients, at most 20 ingredients, at most 10 ingredients, or less.

In some embodiments, the list of starting ingredients includes a combination of existing ingredients and new ingredients. As described herein, examples of new ingredients include, but are not limited to, ingredients synthesized by a biological process, plant-derived ingredients, etc. In some embodiments, the new ingredients may comprise new protein product, for example a new egg white. The new protein product may provide nutritional value with minimal taste and/or odor. For example, the new protein product may be included in smoothie products which prefer to avoid an egg-like sensory profile while still offering egg protein. Accordingly, the new egg white may provide certain cooking functionality like gelation and foaming but may behave different than a naturally occurring hen's egg white in how it interacts with other ingredients because it uses only one protein of the many found in naturally occurring egg whites. In some embodiments, the ingredients may comprise at least 1 new ingredient, at least 2 new ingredients, at least 3 new ingredients, at least 4 new ingredients, at least 5 new ingredients, or more, that are previously unknown or have yet to be characterized.

In some embodiments, the new ingredients may behave in unexpected ways for cooking functionality and sensory due to their interactions with other ingredients. For example, baking require multiple ingredients to work together to provide certain functionality, but a new ingredient may behave differently when used on its own versus when used in recipes alongside other ingredients. As described herein, non-linearities in the behavior of ingredients may arise when ingredients exist individually or when they interact with other ingredients. For example, two ingredients may only cause a certain gelation or a “sensory note” (e.g., smell) if the two ingredients exceed a certain level of inclusion in a recipe and/or depending on the other ingredients present in the recipe. As a result of such interactions and non-linearities between ingredients, a recipe which sees better likability at 2% inclusion than 1% inclusion may not necessarily see better likability at 3% inclusion. Instead, going to 3% inclusion may require adjustments in other ingredient ratios. As described herein, “likability” refers to a level of satisfaction experienced by users who follow a given recipe.

In some embodiments, the method for recipe optimization provided herein may be performed without prior characterization of the starting list of ingredients or the new ingredients as such characterization may be labor intensive and time consuming. Examples of information used to characterize ingredients include includes, but is not limited to, the nutritional profile of the ingredients, physical or chemical properties of the ingredients, smell, taste, optimal concentrations, whether and how an ingredient may interact with another ingredient, optimal cooking temperature, optimal cooking method, and how an ingredient may react to a cooking condition. In embodiments where ingredients have a prior characterization, the seed recipe generator 110 may use the prior characterization to specify constraints in the machine learning model to improve performance of the recipe optimization system described herein.

The food products identified in the initial set of seed recipes include one or more food scrambles. The food scrambles described herein may include any of the scrambles, e.g., egg-like products, described in PCT/US2022/017580, which is incorporated herein by reference in its entirety. In some embodiments, the recipe optimization system 100 collects and stores feedback data on each food product in the food product feedback store 120. In some embodiments, an experimental run is performed during which food products are actually made based on each seed recipe of the initial set. In such embodiments, feedback data is collected from a panel of human raters who taste, consume, or otherwise test one or more of the food products. In some embodiments, the panel of human raters comprises at least 5 human raters, at least 10 human raters, at least 20 human raters, at least 50 human raters, at least 100 human raters, at least 200 human raters, at least 300 human raters, at least 400 human raters, at least 500 human raters, at least 600 human raters, at least 700 human raters, at least 800 human raters, at least 900 human raters, at least 1000 human raters or more.

The food product feedback store 120 stores feedback data characterizing a plurality of attributes of the food products. Examples of attributes described in the stored feedback data include, but are not limited to, flavor, texture, taste, odor, mouth feel, cooking experience, cooking performance, or appearance. In some embodiments, the feedback data describing texture may further describe hardness, cohesiveness, chewiness, foam capacity, or foam stability. In some embodiments, the food recipe feedback store 120 stores structured data including scores or ratings, for example, numbers, percentages, scaled scores, letter ratings, or letter rating with +/− modifiers. In addition, or in the alternative, the food recipe feedback store 120 stores unstructured data such as free-form text (or comments), for example, words or sentences describing the attributes. In some embodiments, the food recipe feedback store 120 stores attributes describing functionalities including, but not limited to, gelation, foaming, gelatinization, or baking.

In some embodiments, the food recipe feedback store 120 stores data describing the likeability for one or more attributes of food products in the seed recipes or on overall likeability of each food product. As described herein, likeability refers to how a human rater enjoys the food product. Accordingly, likeability of a food item may vary between human raters. In some embodiments, the recipe optimization system 100 characterizes likeability with a binary value (e.g., like or dislike). In other embodiments, the recipe optimization system 100 characterizes likeability using structured or unstructured data corresponding to different levels or degrees of likeability ranging, for example, from extreme dislike to extreme like. In one embodiment, levels or degrees of likeability may include extreme dislike, dislike very much, moderate dislike, slight dislike, neutral, slight like, moderate like, like very much and extreme like. In another embodiment, the recipe optimization system 100 determines a likeability score for a food product and categorizes the food product into a level or degree of likeability based on the determined likeability score.

In some embodiments, the food recipe feedback store 120 stores feedback data describing the similarity of one or more attributes between different food products. As described herein, similarity refers to how similar or different a consumer of a food product felt the food product was compared to a control food product. In one embodiment, the control food product is a naturally occurring product, for example a whole hen's egg, egg white, egg yolk etc. In some embodiments, the control food product can be seasoned. Alternatively, the control food product can be unseasoned. In some embodiments, the food recipe feedback store 120 may receive a control food product and the recipe optimization system 101 determines similarity scores for one or more attributes of various food products (e.g., food products identified in the seed recipe) to the control food product. In one embodiment, the recipe optimization system 110 determines similarity scores based on a scale where human raters provided a score (e.g., a likeability score), for example a scale from extreme dislike to extreme like for each attribute. In some embodiments, the food recipe feedback store 120 stores on overall similarity of the food products to a control food product. The recipe optimization system 100 may determine the overall similarity between a food product and a control food product as a function of the similarity scores determined for individual attributes, for example an aggregate similarity score or an average similarity score.

In one embodiment, the recipe optimization system 100 characterizes similarity by determining a binary similarity score (e.g., same and not same/different). In another embodiment, the recipe optimization system 100 characterizes the similarity using structured data or unstructured data corresponding to a plurality of levels or degrees of similarity ranging, for example, from very largely similar to very largely different. In one embodiment, the similarity between a food product and a control food product is characterized based on levels or degrees of similarity including very largely similar, largely similar, moderately largely similar, moderately similar, slight moderately similar, very slightly similar, not similar (different), very slightly different, slightly different, slight moderately different, moderately different, moderately largely different, and very largely different. In some embodiments, each level or degree of similarity corresponds to a range of similarity scores and the similarity of a food product is determined by assigning the food product to a level or degree of similarity corresponding to the determined similarity score.

The candidate recipe generator 130 generates a plurality of recipes which may be offered to a user or used in subsequent experimental runs as part of the recipe optimization process (e.g., candidate recipes). In some embodiments, the candidate recipe generator 130 generates candidate recipes based at least in part on (1) the feedback data stored in the food product feedback data store 130 and (2) one or more recipe constraints. In some embodiments, the candidate recipe generator 130 generates candidate recipes using a machine-learning model described herein to optimize for the observed objective function or an overall score.

In some embodiments, the candidate recipe generator 130 encodes vector representations of each candidate recipe. In such embodiments, each candidate recipe is represented as a vector comprising a plurality of elements corresponding to one or more ingredients from the starting list of ingredients (e.g., water). In one embodiment, the candidate recipe generator 130 generates a floating-point vector for each candidate recipe such that all ingredients in the candidate recipe sum to 100%.

In some embodiments, the candidate recipe generator 130 generates candidate recipes with varying levels of each ingredient of the starting list of ingredients. As described herein, the “level” of an ingredient describes the amount of an ingredient. The level of an ingredient may be characterized as a percentage of the ingredient or a discrete or continuous value. For example, the candidate recipe generator 130 generates candidate recipes with 1 level of each ingredient, 2 levels of each ingredients, 3 levels of each ingredients, 4 levels of each ingredients, 5 levels of each ingredients, 6 levels of ingredients, 7 levels of ingredients, 8 levels of ingredients, 9 levels of ingredients, 10 levels of ingredients, 15 levels of ingredients, 20 levels of ingredients, or more.

The candidate recipe generator 130 may generate candidate recipes based on recipe constraints. In some embodiments, a recipe constraint specifies a threshold amount of one or more of the ingredients within the food product. In some embodiments, a recipe constraint may comprise a maximum amount of lipids and/or proteins. For example, a protein may not exceed a threshold weight percentage (wt %) of the food product (e.g., no more than 20 wt %, no more than 15 wt %, or no more than 10 wt % of the food product). In some embodiments, a recipe constraint describes a desired flavor profile for a food product (e.g., saltiness, sweetness, or sourness, fruity smells, floral smells). In some embodiments, a recipe constraint describes a cooking time for one or more of the ingredients (e.g., minimum time or maximum time that one or more ingredients can be cooked for). In some embodiments, a recipe constraint describes a cooking temperature for one or more of the ingredients (e.g., minimum temperature or maximum temperature that one or more ingredients can be cooked at).

In some embodiments, the candidate recipe generator 130 generates at least 10,000 candidate recipes, at least 20,000 candidate recipes, at least 30,000 candidate recipes, at least 40,000 candidate recipes, at least 50,000 candidate recipes, at least 60,000 candidate recipes, at least 70,000 candidate recipes, at least 80,000 candidate recipes, at least 90,000 candidate recipes, at least 100,000 candidate recipes, at least 150,000 candidate recipes, at least 200,000 candidate recipes, at least 300,000 candidate recipes, at least 400,000 candidate recipes, at least 500,000 candidate recipes, at least 600,000 candidate recipes, at least 700,000 candidate recipes, at least 800,000 candidate recipes, at least 900,000 candidate recipes, at least 1000,000 candidate recipes, or more.

Based on the candidate recipes, the recipe evaluation module 140 selects a predictive model from a set of available machine-learning model to rank candidate recipes generated by the candidate recipe generator 130 based on some recipe-based metric. Accordingly, the predictive model may comprise an objective function trained to generate scores for a given candidate recipe based on one or more provided recipe-based metrics (e.g., likeability, similarity, netc) and rank a set of candidate recipes according to the generated scores. Accordingly, in one embodiment, the recipe evaluation module 140 accesses a database of predictive models and selects a predictive model with an objective function optimized for a particular metric of interest from a set of predictive model.

In some embodiments, the recipe evaluation module 140 selects the predictive model by performing a sweep across multiple machine-learning models to identify a model that has a lowest error (e.g., median absolute error (MdAE), absolute error, mean absolute percentage error, mean absolute error (MAE), mean average error, or root-mean-squared error) for a given validation dataset. In some embodiments, the model selector may comprise a grid search algorithm. In some embodiments, the selected optimal predictive model may comprise a neural network.

Machine learning has benefits far beyond programming efficiency. Machine-learning models may also learn and identify correlations in data that would otherwise not be detected if reviewed by humans. In some implementations, a machine-learning model is asked to group data and make future predictions based on current data. The machine-learning model may determine responses based on the structured data. In other implementations, a machine-learning model may determine responses based on unstructured data, for example a natural language processor.

A machine-learning model may comprise one or more of the following: linear regressions, logistic regressions, classification and regression tree algorithms, support vector machines (SVMs), naive Bayes, K-nearest neighbors, random forest algorithms, boosted algorithms (e.g., AdaBoost, XGBoost and LightGBM), neural networks, convolutional neural networks, and recurrent neural networks. The machine-learning model may be a supervised learning algorithm, an unsupervised learning algorithm, or a semi-supervised learning algorithm.

As described herein, machine-learning models may be used to make predictions using a set of parameters. One class of machine-learning models, artificial neural networks (ANNs), include a portion of a classifier model. Examples of ANNs include feedforward neural networks (such as convolutional neural networks) and recurrent neural networks. Neural networks may employ multiple layers of operations, also referred to as hidden layers, to predict one or more outputs from one or more inputs. For example, as described above, the recipe evaluation module 140 may apply a trained neural network to feedback data for a given food product to output a similarity score for the given food product relative to a control food product. Neural networks may include one or more hidden layers situated between an input layer and an output layer. Each layer of a neural network may specify one or more transformation operations to be performed on input to the layer. Such transformation operations may be referred to as neurons. The output of a particular neuron may be a weighted sum of the inputs to the neuron, adjusted with a bias and multiplied by an activation function, e.g., a rectified linear unit (ReLU) or a sigmoid function. The output of each layer can be used as an input to another layer (e.g., the next hidden layer or the output layer). The output layer of a neural network may be a softmax layer that is configured to generate a probability distribution over two or more output classes.

In particular embodiments, a neural network binary classifier may be trained by comparing predictions made by the underlying machine-learning model to a ground truth or an expected output. An error function may calculate a discrepancy (or an error) between a predicted value and the expected output, and the error may then be iteratively backpropagated through the neural network over multiple cycles, or epochs, in order to change a set of weights that influence the value of the predicted output. Training may cease when the predicted value meets a convergence condition, such as obtaining a small magnitude of calculated error. Multiple layers of neural networks may be employed, creating a deep neural network. Applying a deep neural network may increase the predictive power of a neural network algorithm. In some embodiments, a machine-learning model using a neural network may further include Adam optimization (e.g., adaptive learning rate), regularization, etc. The number of layers, the number of nodes within the layer, a stride length in a convolutional neural network, a padding, a filter, etc. all may be adjustable parameters in a neural network.

In some embodiments, the recipe evaluation module 140 implements additional machine-learning models and/or statistical models to obtain insights from the parameters disclosed herein. Examples of additional machine-learning models include, but are not limited to, logistic regressions, classification and regression tree algorithms, support vector machines (SVMs), naive Bayes, K-nearest neighbors, and random forest algorithms. The recipe evaluation module 140 may implement such algorithms to perform different tasks, for example classification, clustering, density estimation, or dimensionality reduction.

As described above, the recipe evaluation module 140 applies a trained machine-learning model to generate a ranking of candidate recipes. In some embodiments, the recipe evaluation module 140 trains a machine-learning model using a supervised learning approach. For example, the recipe evaluation module 140 may train the selected predictive model based on a time-series of feedback data stored in the feedback store 120. During supervised learning, the machine-learning model can generate a function (or model) from training dataset. In one embodiment, the training dataset is labeled and includes metadata associated therewith. Each entry of the training dataset may be a pair consisting of at least an input object and a desired output value. A supervised learning algorithm may require the user to determine one or more control parameters. These parameters can be adjusted by optimizing performance on a subset, for example, a validation dataset, of the training dataset. After parameter adjustment and learning, the performance of the resulting function/model can be measured on a test dataset that may be separate from the training dataset and validation dataset. In one embodiment, the supervised predictive model may be a score classifier that generates predicted scores and based on the scores. For example, the recipe evaluation model 140 applies the predictive model to rank candidate recipes such that top-ranked candidate recipes may be used in subsequent experimental runs. In another embodiment, the supervised machine-learning model is a multi-class classifier trained to generate predictions for multiple candidate recipes.

Examples of supervised machine-learning models may include, but is not limited to, neural networks, support vector machines, nearest neighbor interpolators, decision trees, boosted decision stump, boosted version of such algorithms, derivatives versions of such algorithms, or their combinations. In some embodiments, the machine-learning models can include one or more of: a Bayesian model, decision graphs, inductive logic programming, Gaussian process regression, genetic programming, kernel estimators, minimum message length, multilinear subspace learning, naive Bayes classifier, maximum entropy classifier, conditional random field, minimum complexity machines, random forests, ensembles of classifiers, and a multicriteria classification algorithm.

In some embodiments, the recipe evaluation module 140 trains a machine-learning model using a semi-supervised learning approach. As described herein, semi-supervised learning involves training a machine-learning model using both labeled and unlabeled data to generate an appropriate function or classifier.

In some embodiments, the recipe evaluation module 140 trains a machine-learning model using an unsupervised learning approach. As described herein, unsupervised learning involves training a machine-learning model to generate a function/model to describe hidden structures using unlabeled data (e.g., a classification or categorization that cannot be directed observed or computed). Since entries in the training data are not labeled, the algorithm is not evaluated based on the accuracy of the structure output by the algorithm. In some embodiments, unsupervised training involves clustering, anomaly detection, and neural networks.

In some embodiments, the recipe evaluation module 140 trains a machine-learning model using a semi-supervised learning approach. As described herein, semi-supervised learning involves training a machine-learning model using both labeled and unlabeled data to generate an appropriate function or classifier. In some embodiments, the machine-learning model may use a reinforced learning approach. During reinforced learning, the algorithm learns how to act given an observation of the world. Every action may have some impact in the environment, and the environment can provide feedback to the algorithm to guide its training.

In some embodiments, the recipe evaluation module 140 applies a machine-learning model to generate decision trees based on the set of parameters. As described herein, the set of parameters refers to an input feature set provided to the model during training, validation, and testing. Examples of such input features include, but are not limited to, the ingredient list, type of protein, and quantity of ingredients. The decision tree may include a threshold value for one or more parameters of the set of parameters. The threshold value may determine which branch of the tree a dataset should be classified into. The trained model may build a decision tree at least, in part, by searching for the most informative nodes (e.g., parameters) for a given dataset. In one embodiment, the most informative nodes are node of a decision tree with the highest value of information gain, which are used as the feature for splitting the node. In some embodiments, the recipe evaluation module 140 prunes the decision tree by reducing the number of parameters within a set of a parameters to a subset of the most relevant parameters. For example, the recipe evaluation module 140 may prune the decision tree down to a subset of parameters including the minimum number of parameters for classifying a dataset within a specified sensitivity or specificity, (e.g., 90% sensitivity or specificity).

In some embodiments, the recipe evaluation module 140 may train the machine-learning model by grid sweeping across multiple competing models. For example, the recipe evaluation module 140 may use ElasticNet with alpha/penalty terms from 0 to 1 at increments of 0.1. In some embodiments, the recipe evaluation module 140 may use ElasticNet with alpha/penalty terms from 0 to 1 at increments of 0.1. As another example, the recipe evaluation module 140 may train ElasticNet with L1 ratios from 0 to 1 at increments of 0.1. As another example, the recipe evaluation module 140 may train SVR with linear, poly, and radial bias function kernels. In one embodiment, the recipe evaluation module 140 may use single tree decision tree regression at different max levels up to 10 levels. In another embodiment, the recipe evaluation module 140 may use random forest with single tree decision tree estimators at different max levels up to 10 levels and at different max number of estimators up to 70 estimators. In another embodiment, the evaluation module 140 may use AdaBoost with single tree decision tree estimators at different max levels up to 10 levels and at different max number of estimators up to 70 estimators.

In some embodiments, data from each experimental run may be divided into a training dataset, a validation dataset, and a test dataset. A training dataset may comprise data used to train the machine-learning models. A validation dataset may comprise data used to compare the performance of the machine-learning models. The validation dataset may also comprise data used to validate a machine-learning model trained on the training dataset. A test dataset may comprise data used to determine how the machine-learning models may perform in the future. In some embodiments, the training dataset may comprise 50% to 98% of the data. In some embodiments, the validation dataset may comprise 1% to 25% of the data. In some embodiments, the testing dataset may comprise 1% to 25% of the data. The recipe vector may provide the input for each data point and the observed objective function score from human raters may be used as output such that multiple instances of the same recipe appear to the model training as one data point for each time a human rater scores that recipe. The system may choose the “best model” by finding the model with the lowest error in the validation dataset.

The training data upon which the machine-learning model is trained may include entries of recipes and the corresponding individual ingredients for the recipe (e.g., protein, amount of individual ingredients, and order of ingredients). For example, training data may be collected for 100 recipes over a period of 11 weeks. Each entry of training data may further include feedback for each recipe, for example sensory panels from 4 to 6 human raters during each week.

In some embodiments, the recipe evaluation module 140 applies a natural language processing (NLP) model to process the free-form text in feedback data accessed from the food product feedback store 120. In some embodiments, an objective function implemented by the recipe evaluation module 140 is trained to optimize for one or more NLP-derived metrics including, but not limited to, accuracy, precision, recall, F1 score, area under the curve, mean reciprocal rank, mean average precision, room mean squared error, mean absolute percentage error, bilingual evaluation understudy, or perplexity.

As described above, the recipe evaluation module 140 applies the selected predictive model to rank the plurality of candidate recipes generated by the candidate recipe generator 130. In one embodiment, the recipe evaluation module 140 generates a ranking of candidate recipes based on the individual contributions or effects of each ingredient and the interactions with other ingredients. In one embodiment, the recipe evaluation module 140 ranks candidate recipes according to sensory scores (scores for certain sensory notes) or likeability scores described above. The recipe evaluation module 140 applies a predictive model with an objective function trained to optimize for the individual contributions or effects of each ingredient and the interactions with other ingredients. In some embodiments, the interactions of an ingredient with other ingredients may comprise non-linearities or non-linear behavior or characteristics. For example, a certain gelation may only start appearing when two ingredients exceed a certain level of inclusion. As another example, a “sensory note” such as a smell may only appear when an ingredient exceeds a threshold level of inclusion or in certain recipes involving the ingredient and a certain combination of other ingredients.

In some embodiments, the recipe evaluation module 140 generates a ranking of candidate recipes based on the likeability of individual attributes. In such embodiments, the recipe evaluation module 140 applies a predictive model with an objective function trained to optimize for the likeability an individual attribute. For example, the objective function may maximize predicted scores for likeability of each individual attribute (“local likeability scores”). In such embodiments, the predictive model 140 may generate a single ranking based on likeability for a particular attribute or multiple rankings based on likeability of various attributes. In another embodiment, the predictive model may comprise an objective function trained based on overall likeability. For example, the objective function may maximize predicted scores for overall likeability (“global likeability scores”). In such embodiments, the predictive model 140 may implement the techniques described above to determine overall likeability scores.

In other embodiments, the recipe evaluation module 140 generates a ranking of candidate recipes based on the similarity of a food product corresponding to each candidate recipe and a control sample (e.g., a control food product). In such embodiments, the recipe evaluation module 140 applies a predictive model with an objective function trained based to optimized for the similarity of a candidate receipt to a control sample. In one embodiment, the recipe evaluation module 140 may apply a predictive model with an objective function trained based on similarity scores for individual attributes. For example, the objective function may maximize predicted similarity scores for each individual attribute relative to a control sample (“local similarity scores”). In another embodiment, the recipe evaluation module 140 may apply a predictive model with an objective function trained based on overall similarity scores. For example, the objective function may maximize predicted overall similarity scores (“global similarity scores”).

In other embodiments, the recipe evaluation module 140 generates a ranking of candidate recipes based on nutritional similarity of a candidate recipe to a control sample. In such embodiments, the recipe evaluation module 140 applies a predictive model with an objective function trained based on similarity scores between the nutritional profiles of a candidate recipe and a control sample. For example, the nutritional profile of a food product may include an amino acid profile, which the recipe evaluation module 140 compares against a target nutritional profile in a naturally occurring product. In some embodiments, the amino acid profile includes a protein digestibility corrected amino acid score (PDCAAS). PDCAAS is method of evaluating the quality of a protein based on both the amino acid requirements of humans and their ability to digest it. PDCAAS rating was adopted by the US FDA and the Food and Agriculture Organization of the United Nations/World Health Organization (FAO/WHO) in 1993 as “the preferred “best” method to determine protein quality. Using the PDCAAS method, predictive model determines protein quality scores by comparing the amino acid profile of the specific food protein against a standard amino acid profile with the highest possible score being a 1.0. Accordingly, the predicted protein quality score provides that, after digestion of the protein, it provides per unit of protein 100% or more of the indispensable amino acids required. The predictive model may determine the predicted protein quality score according to the below equation:

(mg of limiting amino acid in 1 g of test protein/mg of same amino acid in 1 g of reference protein)×fecal true digestibility percentage.

In other embodiments, the recipe evaluation module 140 generates a ranking of candidate recipes based on based on cooking experience and/or appearance of the food product during preparation. In such embodiments, the recipe evaluation module 140 applies a predictive model with an objective function trained to determine a score for a candidate recipe based on cooking experience or appearing during preparation.

The recipe evaluation module 40 (and/or the underlying predictive model) may further normalize the scores generated by the predictive model prior to ranking the candidate recipes. In one embodiment, the recipe evaluation module 140 applies Z-score normalization to normalize the scores per attribute per human rater. The recipe optimization module applies z-score normalization to rating scores provided by individual human raters after generation of the recipe and evaluation by the individual human raters. As described herein, “z-score normalization” normalizes every value in a dataset such that the mean of all the values is 0 and the standard deviation is 1. Accordingly, z-score normalization can help alleviate natural differences between human rater response styles. In other embodiments, recipe evaluation module 140 may rank the plurality of candidate of recipes based on raw scores.

In some embodiments, the recipe optimization system 100 provides the method for recipe optimization may provide an interface for facilitating human-machine collaboration. In some embodiments, the interface may provides graphical and numerical predictions of individual attribute levels and overall likeability levels, in response to one or more new hypotheses that may be input by one or more user provided by a user(s) via the interface.

In some embodiments, the interface comprises color representations or a color scale indicative of the predicted individual attribute levels, predicted overall likeability, and/or predicted overall similarity levels. For example, a green color may mean highly similar while a red color may mean highly different. Shades of color may be used too. For example, the darker the color, the higher the that global or local score.

The recipe evaluation module 140 selects one or more top-ranked candidate recipes for one or more subsequent experimental runs to further optimize the objective function of the predictive model. In some embodiments, recipe evaluation module 140 selects at least 1 top-ranked candidate recipe, at least 2 top-ranked candidate recipes, at least 3 top-ranked candidate recipes, at least 4 top-ranked candidate recipes, at least 5 top-ranked candidate recipes, at least 10 top-ranked candidate recipes, at least 20 top-ranked candidate recipes, at least 30 top-ranked candidate recipes, at least 40 top-ranked candidate recipes, at least 50 top-ranked candidate recipes, at least 60 top-ranked candidate recipes, at least 70 top-ranked candidate recipes, at least 80 top-ranked candidate recipes, at least 90 top-ranked candidate recipes, at least 100 top-ranked candidate recipes, or more top-ranked candidate recipes may be selected for subsequent experimental runs to further optimize the objective function. In some embodiments, the recipe evaluation module 140 provides instructions for a user to perform at least 5 experimental runs, at least 10 experimental runs, at least 20 experimental runs, at least 30 experimental runs, at least 40 experimental runs, at least 50 experimental runs, at least 60 experimental runs, at least 70 experimental runs, at least 80 experimental runs, at least 90 experimental runs, at least 100 experimental runs, or more experimental runs may be performed. In some embodiments, the recipe evaluation module 140 provides instructions for a user to perform the initial and subsequent experimental runs over a period of multiple days, weeks or months, for example 5 to 100 days, 10 to 100 days, 20 to 100 days, 30 to 100 days, 40 to 100 days, 50 to 100 days, 60 to 100 days, 70 to 100 days, 80 to 100 days, or 90 to 100 days.

In some embodiments, the recipe evaluation module 140 generates modifications to one or more candidate recipes with instructions to implement the modifications during the subsequent experimental runs. In some embodiments, the recipe evaluation module 140 generates modifications made to an existing recipe based on inputs from human supervisors. Examples of such modifications include, but are not limited to, increasing the amount of one or more ingredients, lowering the amount of one or more ingredients, changing the order of the ingredients, adding one or more ingredients which may comprise new ingredient, removing one or more ingredients, or adjusting cooking parameters (e.g., cooking temperature, cooking duration, cooking condition, cooking method). In some implementations, new ingredients may be incorporated during the optimization phase between weeks. In such circumstances, the recipe evaluation module 140 may initialize the value for that new ingredient to zero for all historical data in the models.

In some embodiments, the method 100 may comprise repeating 102 through 106 on a plurality of other food products made using the one or more top-ranked candidate recipes or other newly-generated top-ranked candidate recipes, until the objective function has been optimized to meet a set of target criteria for the plurality of attributes. Non-limiting target criteria may comprise nutritional profile, composition, concentration, cooking functionality, likeability scores, and similarity scores.

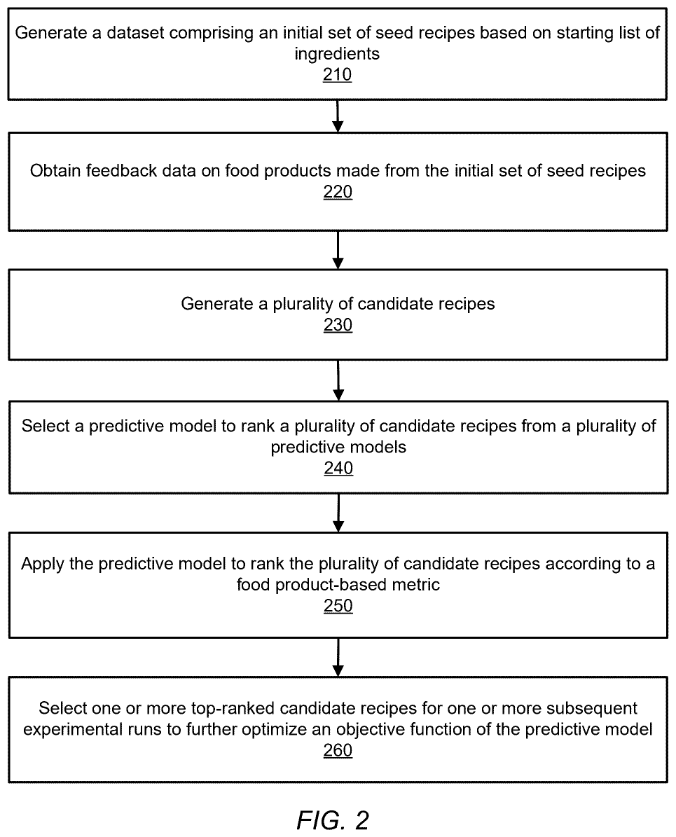

FIG. 2 is a flowchart illustrating a method for optimizing candidate recipes, in accordance with some embodiments. The recipe optimization system 100 generates 210 a dataset comprising an initial set of seed recipes based on a list of starting ingredients. The recipe optimization system 100 obtains 220 feedback data on food products made from the initial set of seed recipes. In some embodiments, the feedback data may be obtained from a panel of human raters who taste or consume or otherwise test one or more of the food products. The recipe optimization system 100 generates a plurality of candidate recipes, which may be used in subsequent experimental runs. The recipe optimization system 100 may generate candidate recipes based on at least feedback data collected from the seed recipes and one or more recipe constraints.

The recipe optimization system 100 selects 240 an optimal predictive model from among a plurality of machine learning models to rank the generated candidate recipes according to some recipe-based metric. The recipe optimization system 100 applies 250 the predictive model to rank the plurality of candidate recipes according to a selected recipe-based metric. The recipe optimization system 100 selects 260 the one or more top-ranked candidate recipes from one or more subsequent experimental runs to further optimize an objective function of the selected predictive model.

In some embodiments, the recipe optimization system 100 implements an exploration process and an exploitation process. In some embodiments, steps 230 and 240 of FIG. 2 correspond to an exploration phase and steps 250 and 260 of FIG. 2 correspond to an exploitation phase. In some embodiments, recipe optimization system 100 may adjust each of the exploration phase and the exploitation phase for any subsequent experimental runs (e.g., for an n^{th} experimental run, n is an integer greater than 2). In some embodiments, the recipe optimization system 100 may adjust each of the exploration phase and the exploitation phase from 0% to 100% relative to each other during in each experimental run. For example, the exploration phase can be 0%, 10%, 20%, 30%, 40%, 50%, 60%, 70%, 80%, 90%, or 100% of the exploitation phase and the exploitation phase may be 100%, 90%, 80%, 70%, 60%, 50%, 40%, 30%, 20%, 10%, or 0% of the exploration phase during each experimental run. In some embodiments, the exploration phase comprises a plurality of candidate exploration recipes. In some embodiments, the exploration phase can comprise a plurality of samples (e.g., food products). In some embodiments, the exploitation phase can comprise a plurality of candidate exploitation recipes. In some embodiments, the exploitation phase can comprise a plurality of samples (e.g., food products). The recipe optimization system 100 may adjust a number of the plurality of candidate exploration recipes or the plurality of samples used in the exploration phase and a number of the plurality of candidate exploitation recipes or the plurality of samples used in the exploitation phase from 0% to 100% relative to each other during each experimental run.

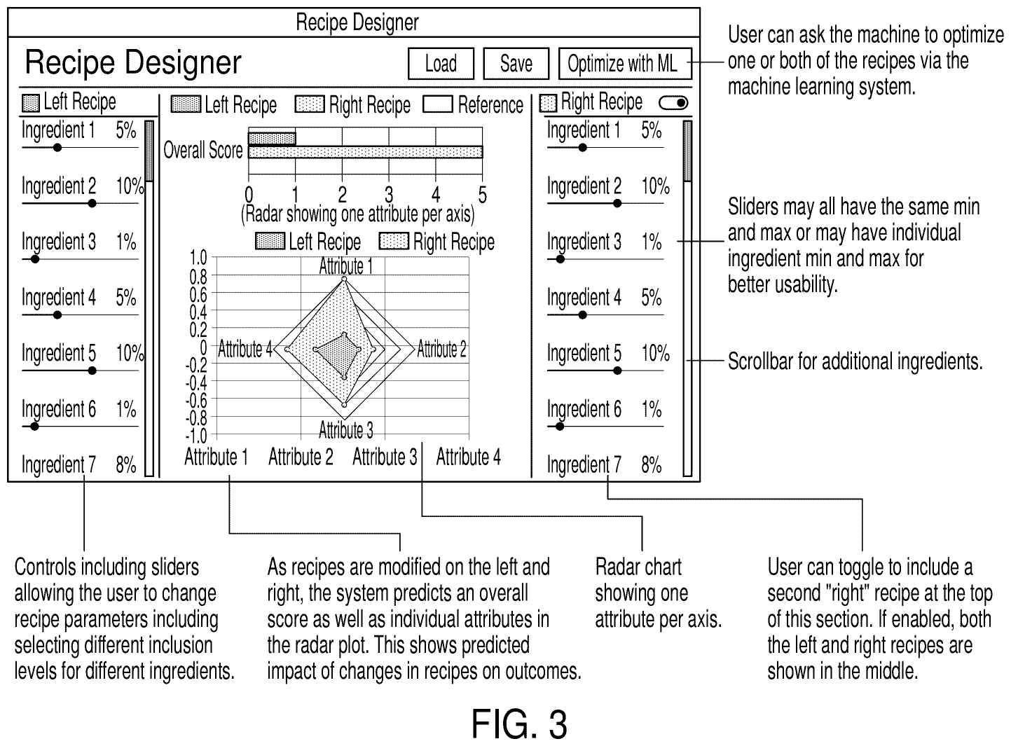

FIG. 3 illustrates an example user interface for designing a user interface, according to some embodiments. Left Recipe is shown on the left side of the UI. Right Recipe is shown on the right side of the UI. On both sides (for Left Recipe and Right Recipe), there are sliders for each ingredient in the recipes, which can be changed to simulate different inclusion levels for different ingredients. At the center of the UI, a z-score on a 0 to 5 scale is visualized for each individual attribute. Furthermore, the overall score is visualized at the top of the UI for both recipes. Both the left and right recipes can be visualized at the center of the UI for each individual attribute and the overall score.

### II. Computer Systems

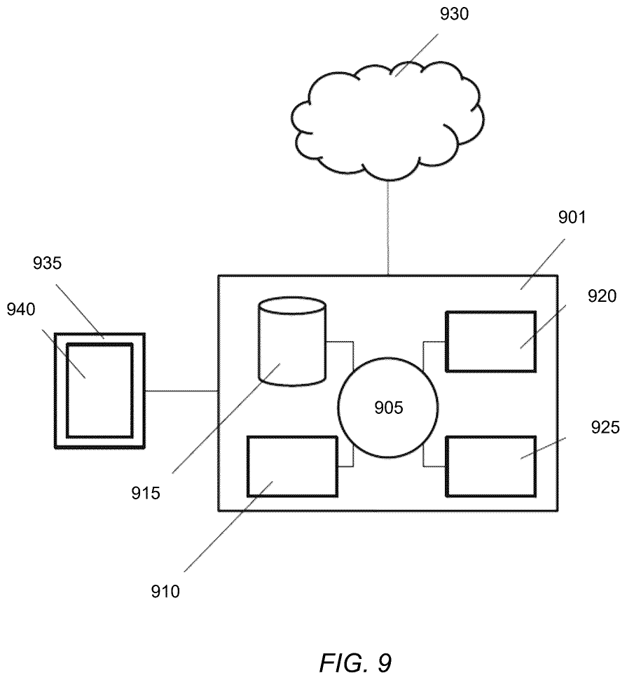

The present disclosure provides computer systems that are programmed to implement methods of the disclosure. FIG. 9 illustrates a computer system 901 that is programmed or otherwise configured to optimize recipes, in accordance with some embodiments. The computer system 901 can regulate various aspects of machine learning analysis of the present disclosure, such as, for example, implementing a neural network. The computer system 901 can be an electronic device of a user or a computer system that is remotely located with respect to the electronic device. The electronic device can be a mobile electronic device.

The computer system 901 includes a central processing unit (CPU, also “processor” and “computer processor” herein) 905, which can be a single core or multi core processor, or a plurality of processors for parallel processing. The computer system 901 also includes memory or memory location 910 (e.g., random-access memory, read-only memory, flash memory), electronic storage unit 915 (e.g., hard disk), communication interface 920 (e.g., network adapter) for communicating with one or more other systems, and peripheral devices 925, such as cache, other memory, data storage and/or electronic display adapters. The memory 910, storage unit 915, interface 920 and peripheral devices 925 are in communication with the CPU 905 through a communication bus (solid lines), such as a motherboard. The storage unit 915 can be a data storage unit (or data repository) for storing data. The computer system 901 can be operatively coupled to a computer network (“network”) 930 with the aid of the communication interface 920. The network 930 can be the Internet, an internet and/or extranet, or an intranet and/or extranet that is in communication with the Internet. The network 930 in some cases is a telecommunication and/or data network. The network 930 can include one or more computer servers, which can enable distributed computing, such as cloud computing. The network 930, in some cases with the aid of the computer system 901, can implement a peer-to-peer network, which may enable devices coupled to the computer system 901 to behave as a client or a server.

The CPU 905 can execute a sequence of machine-readable instructions, which can be embodied in a program or software. The instructions may be stored in a memory location, such as the memory 910. The instructions can be directed to the CPU 905, which can subsequently program or otherwise configure the CPU 905 to implement methods of the present disclosure. Examples of operations performed by the CPU 905 can include fetch, decode, execute, and writeback.

The CPU 905 can be part of a circuit, such as an integrated circuit. One or more other components of the system 901 can be included in the circuit. In some cases, the circuit is an application specific integrated circuit (ASIC).

The storage unit 915 can store files, such as drivers, libraries and saved programs. The storage unit 915 can store user data, e.g., user preferences and user programs. The computer system 901 in some cases can include one or more additional data storage units that are external to the computer system 901, such as located on a remote server that is in communication with the computer system 901 through an intranet or the Internet.

The computer system 901 can communicate with one or more remote computer systems through the network 930. For instance, the computer system 901 can communicate with a remote computer system of a user (e.g., a mobile computing device). Examples of remote computer systems include personal computers (e.g., portable PC), slate or tablet PC's (e.g., Apple® iPad, Samsung® Galaxy Tab), telephones, Smart phones (e.g., Apple® iphone, Android-enabled device, Blackberry®), or personal digital assistants. The user can access the computer system 901 via the network 930.

Methods as described herein can be implemented by way of machine (e.g., computer processor) executable code stored on an electronic storage location of the computer system 901, such as, for example, on the memory 910 or electronic storage unit 915. The machine executable or machine readable code can be provided in the form of software. During use, the code can be executed by the processor 905. In some cases, the code can be retrieved from the storage unit 915 and stored on the memory 910 for ready access by the processor 905. In some situations, the electronic storage unit 915 can be precluded, and machine-executable instructions are stored on memory 910.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 901, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 901 can include or be in communication with an electronic display 835 that comprises a user interface (UI) 840 for providing, for example, an interface for modifying machine learning parameters. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 905. The algorithm can, for example, optimize recipes.

While preferred embodiments of the present disclosures have been shown and described herein, it will be obvious to those skilled in the art that such embodiments are provided by way of example. It is not intended that the present disclosures be limited by the specific examples provided within the specification. While the present disclosures have been described with reference to the aforementioned specification, the descriptions and illustrations of the embodiments herein are not meant to be construed in a limiting sense. Numerous variations, changes, and substitutions will now occur to those skilled in the art without departing from the present disclosures. Furthermore, it shall be understood that all aspects of the present disclosures are not limited to the specific depictions, configurations or relative proportions set forth herein which depend upon a variety of conditions and variables. It should be understood that various alternatives to the embodiments described herein may be employed. It is therefore contemplated that the present disclosures shall also cover any such alternatives, modifications, variations or equivalents. It is intended that the following claims exemplify the scope of the present disclosures and that methods and structures within the scope of these claims and their equivalents be covered thereby.

### EXAMPLES

The following examples are provided to further illustrate some embodiments of the present disclosure, but are not intended to limit the scope of the disclosure; it will be understood by their exemplary nature that other procedures, methodologies, or techniques known to those skilled in the art may alternatively be used.

### Example 1: Example Recipe Optimization Implementation

This exemplary example shows the use and effectiveness of the methods and systems described herein for recipe optimization.

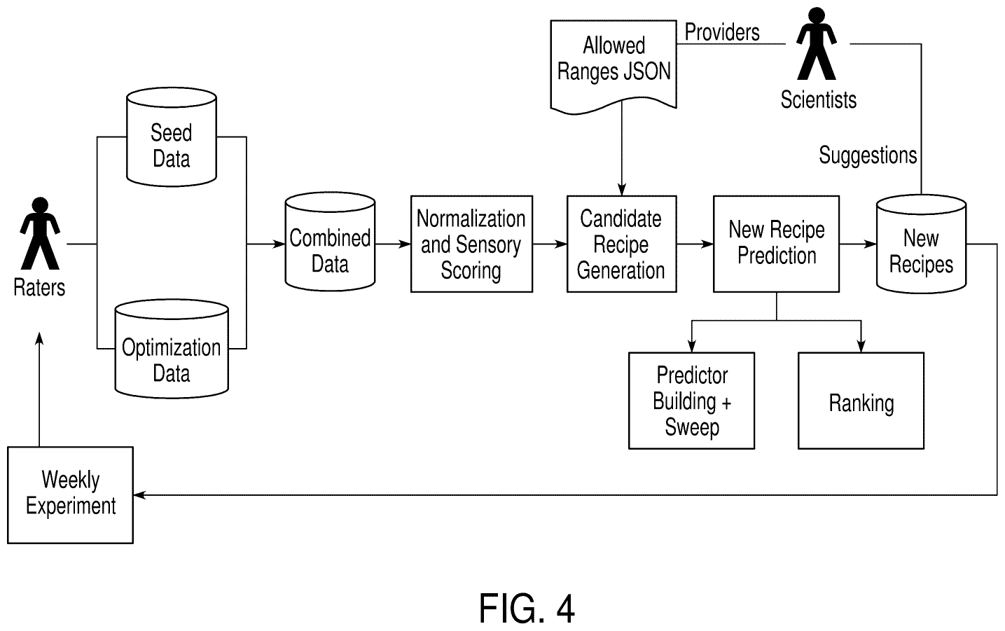

FIG. 4 is a schematic illustration of a method for optimizing candidate recipes, in accordance with some embodiments. FIG. 4 is described in the context of an example implementation of the recipe optimization process. This example implementation targeted at least 100 recipes with one week of contingency. Food products were prepared with an initial random set of recipes (“seed recipes”) of 20 seed recipes. The seed recipes were run for the first two weeks of experimentation. Sensory panels consisted of 4-6 human raters in each panel each week were asked to taste 2 experimental recipes and a control food product: a whole hen's egg scramble without seasoning. These samples, provided with names not meaningful to the human rater except with one labeled as “control”, came with a digital survey which asked for a likeability score (how much the human rater likes the sample) for all samples on a scale from dislike extremely to like extremely (Table 1).

TABLE 1
Numerical encoding of likeability scores

| Shown to Rater | Numerical Encoding |
|---|---|
| Dislike extremely | 0 |
| Dislike very much | 1 |
| Dislike moderately | 2 |
| Dislike slightly | 3 |
| Neither like nor dislike | 4 |
| Like slightly | 5 |
| Like moderately | 6 |
| Like very much | 7 |
| Like extremely | 8 |

For all non-control samples, human raters provided similarity scores to the control scramble on each attribute of flavor, texture, and appearance using a scale from “not” different to “very largely” different (Table 2). Finally, human raters provided an overall similarity score on the same scale as in Table 2.

TABLE 2
Numerical encoding of similarity scores

| Shown to Rater | Numerical Encoding |
|---|---|
| No/None | 6 |
| Very slightly different | 5 |
| Slight moderately | 4 |
| Moderately | 3 |
| Moderately largely | 2 |
| Largely | 1 |
| Very largely | 0 |

A single objective function (1) was optimized for the recipes, wherein/is likeability score, s is similarity score for an attribute, and sₒᵥₑᵣₐₗₗ is the overall similarity score:

$$𝓎 = \frac{10 * l + 4 * {s}_{overall} + \sum s}{18} . \qquad ( 1 )$$

Z-score normalization was used to normalize the scores per attribute per human rater in the objective function (1) across all samples the human rater evaluated.

In the optimization phase starting with week 3, human experimenters can adjust between exploration and exploitation throughout the weeks of experiments by deciding how many fully random exploration recipes to generate and how many exploitation recipes to prioritize via a predictive model.

To build exploitation recipes, 100,000 recipes meeting the allowed ranges criteria (e.g., nutritional profile, concentration) provided by the human experimenters were generated (“candidate recipes”). Then, the candidate recipes were ranked by predicted sensory score using the objective function and trained machine learning predictor.

The recipe was represented as a floating point vector (“recipe vector”) with each element a single ingredient such that all ingredients add up to 100%.

To make predictions on candidate recipes for the purposes of ranking, a machine-learning model (“ML model”) was trained between experiments by “grid” sweeping across multiple competing models. In this example, 60% of data went into a training dataset with 20% for a validation dataset and 20% for a test dataset. The recipe vector provided the input for each data point and the ML model used the observed objective function score from human raters as output such that multiple instances of the same recipe appeared to the model training as one data point for each time a human rater scored that recipe. The best model was chosen for the week by finding the model with the lowest median absolute error in the validation dataset. The test dataset served only to provide an estimation of final model performance for human experimenters monitoring the experiment.

As part of the sweep, the ML model tried ElasticNet with alpha/penalty terms from 0 to 1 at increments of 0.1. Simultaneously, the ML model trained ElasticNet with L1 ratios from 0 to 1 at increments of 0.1.

As part of the sweep, the ML model tried SVR with linear, poly, and radial bias function kernels.

As part of the sweep, the ML model tried single tree decision tree regression at different max levels up to 10 levels.

As part of the sweep, the ML model tried random forest with single tree decision tree estimators at different max levels up to 10 levels and at different max number of estimators up to 70 estimators.

As part of the sweep, the ML model tried AdaBoost with single tree decision tree estimators at different max levels up to 10 levels and at different max number of estimators up to 70 estimators.

The system consistently chose AdaBoost or Random Forest for its predictor. Specifically, the final week predictor used Random Forest with 15 estimators of max depth 1 to yield a median absolute validation error of 0.28 and mean absolute error of 0.54. The test set performance remained similar with an MAE of 0.64 and MdAE of 0.67. The means suggested slightly but acceptable overfitting.

The top-ranked candidate recipes (“exploitation recipes”) were selected to run in the upcoming week's experiments. In week 7, a new ingredient based on qualitative feedback was also introduced by the human experimenters.

A user interface (“UI”) (for example, the interface illustrated in FIG. 3) for machine-learning and human experimenters collaboration was used in the decision making process. The user interface used both the latest overall predictor as well as attribute level predictors for likability, taste difference, texture difference, appearance difference, and overall difference. This method trained those other predictors in the same way as the overall predictor but, instead of using the objective function, it simply used the z-score normalized value for each attribute as the response.

As these experiments happened over multiple weeks, new hypotheses (“expert knowledge”) were formulated by human experimenters observing the results. This expert knowledge was used in multiple ways to create hybrid machine and human collaboration within this optimization problem. Human experimenters observing the data may want to include a manually built recipe from human observation of results. For example, this may include re-running a prior recipe for an additional replicate on that experiment, a minor modification to an existing recipe, or a specific hypothesis.

Incorporation of expert knowledge was encouraged to support hypothesis generation and offer a tool to ask the current predictor to estimate performance of human experimenters-proposed recipes.

Replicates were not incorporated in optimization. Therefore, to further evaluate the final recipes, two best recipes as recommended by the ML method used herein were provided to a 5-person sensory panel. The same rater form was used and regular optimization took place in week 12. Human rater data collected on the final two best recipes were compared to sensory data collected on manually built recipes which was used as a system benchmark.

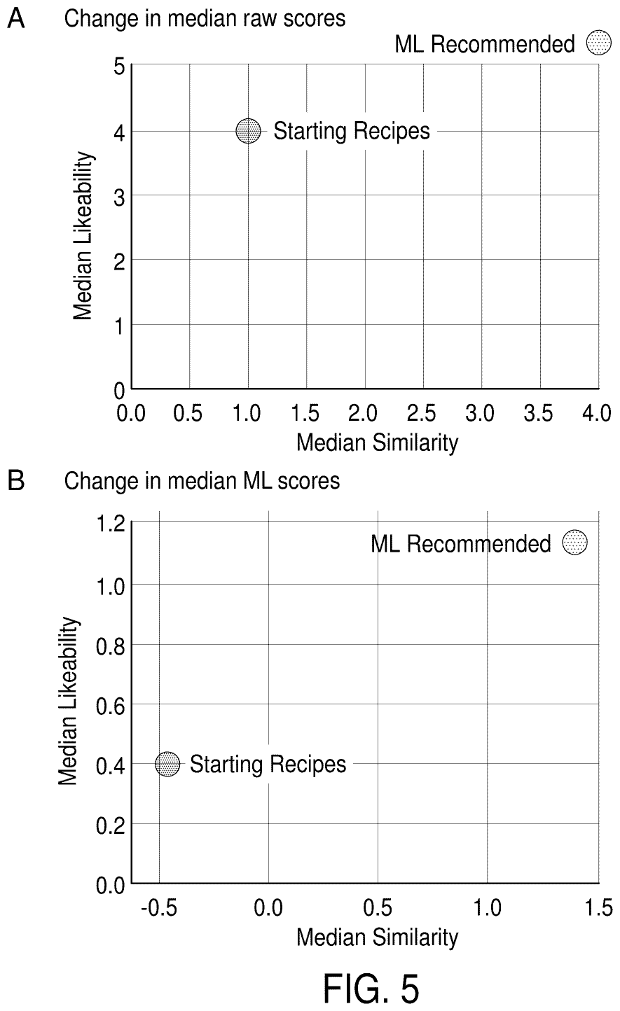

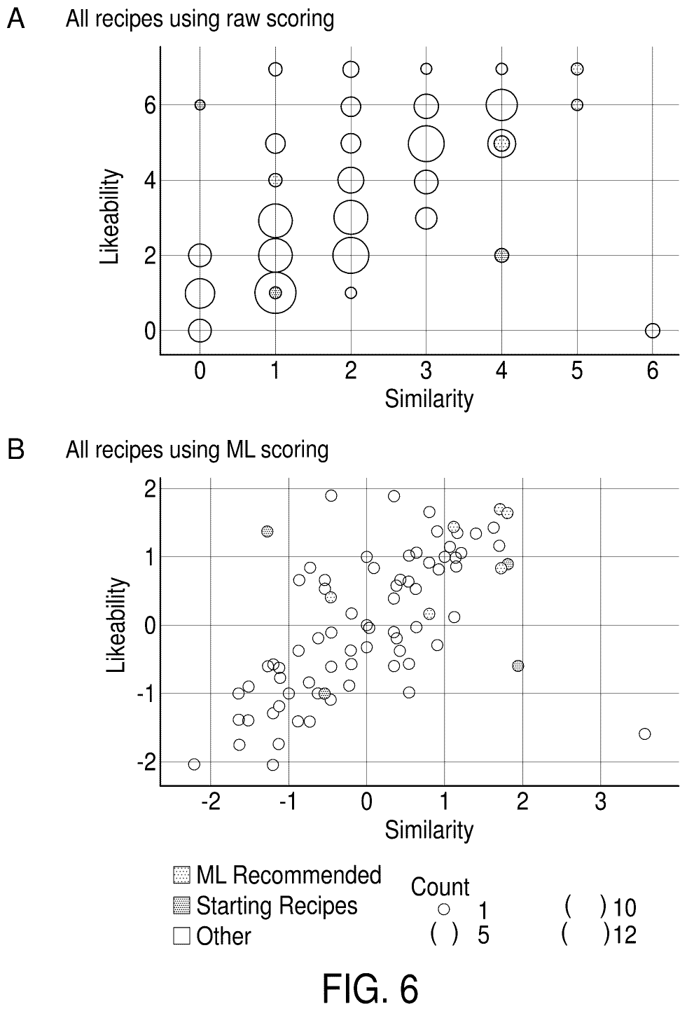

Through the method provided herein, a rapid and reliable recipe optimization for food application can be achieved. FIG. 5 illustrates medial similarity and median liability scores for recipes generated using raw scores and machine-learning scores, in accordance with some embodiments. Referring to FIG. 5, machine-learning recommended recipes exhibits both higher median similarity scores and higher median likeability scores assessed using raw scores (FIG. 5A) and using ML scores (FIG. 5B). FIG. 6 illustrates a histogram of likability and similarity scores of recipes during the recipe optimization process, in accordance with some embodiments. FIG. 6 shows hat starting with a randomized set of recipes, ML enabled recipe optimization method as described herein guided the optimization process and generated recipes with high likeability and similarity scores, indicating the effectiveness of the ML enabled recipe optimization method.

In addition, through the recipe optimization method provided herein, hypotheses on ingredients, recipes and food sciences based on the one or more top-ranked candidate recipes or other newly generated top-ranked candidate recipes may be formulated. In some embodiments, hypotheses on ingredients, recipes and food sciences may be formulated based on the feedback data. The hypotheses formulated herein will provide guidance on future recipe optimizations for other recipes with a different starting list of ingredients.

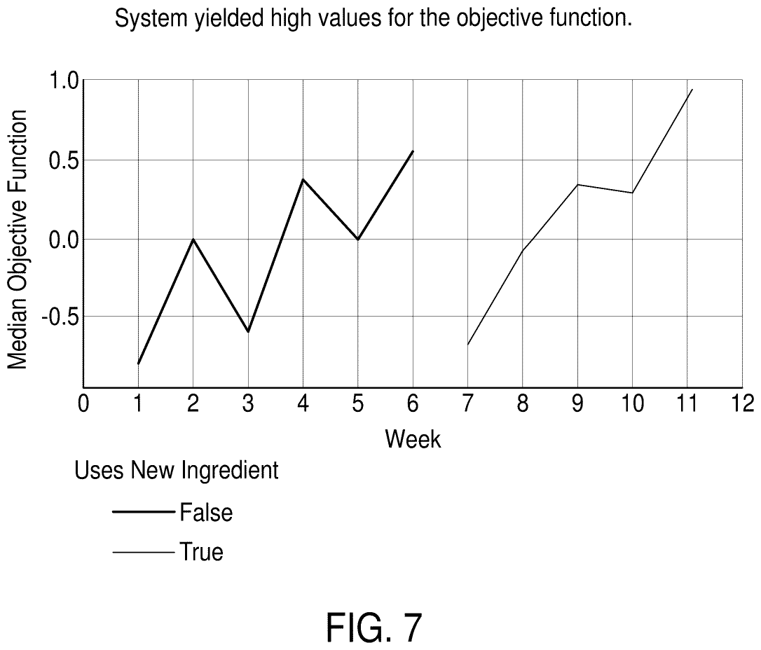

FIG. 7 illustrates a graph of objective function scores versus time (in weeks), in accordance with some embodiments. A total of 112 recipes were evaluated in this example. The food scrambles generated using the ML recommended recipes exhibited much higher similarity and likability scores than the starting recipes in week 1, demonstrating the ML method's effectiveness (FIG. 7).

Significantly improved objective function scores at week 11 were observed compared to week 1 (p<0.05, Mann-Whitney U). A median objective function value of −0.88 in week 1 versus 0.92 in week 11 were found (FIG. 7). In addition, only one scramble from week 1 showed a positive likability score whereas 7 of the 8 exploitation recipes from week 11 reported positive likability.

As illustrated in FIG. 7, in general, improved scores on likeability and similarity of food scrambles were reported from week to week. The temporary sharp decrease in scores observed at week 7 was due to the introduction of the new ingredient, making the total non-water ingredients from 12 to 13. However, these data suggested both optimizations happened quickly in about 50 recipes and recovered to scores from prior experimental runs in about 50 recipes when introducing a new unknown ingredient.

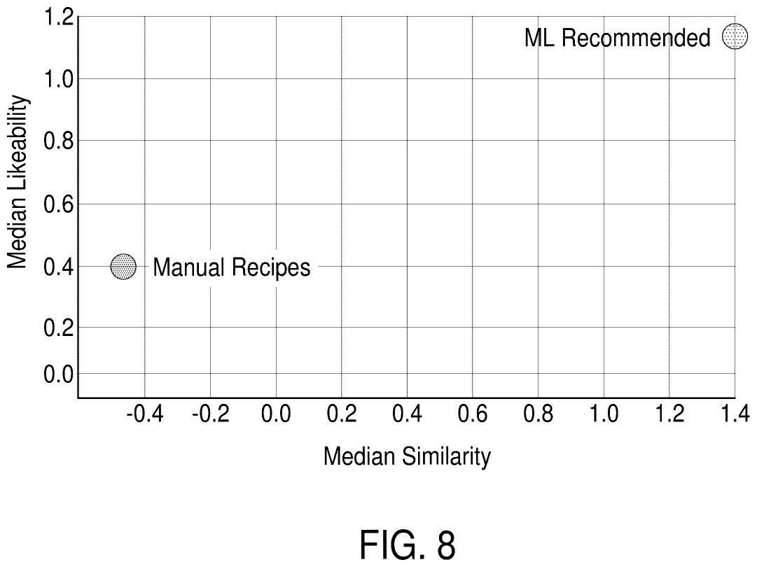

In comparison, human experimenters provided a limited number (about 12) of manual recipes formulated based on results of the ML optimization but with some modifications. However, in general, those recipes did not rank highly. FIG. 8 illustrates a comparison of subjective function scores of machine-learning recommended recipes and manual recipes, in accordance with some embodiments. Those recipes were also evaluated by the 5-person sensory panel. Referring to FIG. 8, ML recommended recipes had significantly higher objective scores than those manual recipes (p<0.05, Mann Whitney U).

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the present disclosure may be employed in practicing the present disclosure. It is intended that the following claims define the scope of the present disclosure and that methods and structures within the scope of these claims and their equivalents be covered thereby.

What is claimed is:

1. A computer-implemented method for recipe optimization for food applications, comprising:
(a) generating a seed dataset comprising an initial randomized set of seed recipes based on a list of starting ingredients;
(b) obtaining feedback data for a plurality of food products made using the initial randomized set of seed recipes during an initial experimental run, wherein the feedback data comprises a plurality of scores and comments on a plurality of attributes for each food product;
(c) generating a plurality of candidate recipes based at least on (1) the feedback data and (2) one or more recipe constraints, wherein each candidate recipe is represented as a vector comprising a plurality of elements that correspond to one or more ingredients from the starting list of ingredients;
(d) applying a predictive model to rank the plurality of candidate recipes, wherein the predictive model comprises an objective function that generates a score for each candidate recipe represented as the vector based at least on (1) likeability for each individual attribute, (2) overall likeability, or (3) similarity to a control sample; and
(e) selecting one or more top-ranked candidate recipes for one or more subsequent experimental runs to further optimize the objective function.

2. The method of claim 1, wherein the plurality of attributes comprise flavor, texture, mouth feel, taste, odor or appearance.

3. The method of claim 1, wherein the plurality of attributes relate to cooking functionality including gelation, foaming or baking.

4. The method of claim 1, wherein the recipe optimization is performed on one or more new ingredients that are previously unknown or have yet to be characterized.

5. The method of claim 1, wherein the recipe optimization is performed without prior characterization of the starting list of ingredients or one or more new ingredients.

6. The method of claim 1, wherein the feedback data is generated or provided by a panel of human raters.

7. The method of claim 6, wherein the comments comprise free-form text from the panel of human raters.

8. The method of claim 1, wherein the control sample comprises a naturally occurring product.

9. The method of claim 8, wherein the naturally occurring product comprise a whole hen's egg.

10. The method of claim 8, wherein the control sample is unseasoned.

11. The method of claim 8, wherein the control sample is seasoned.

12. The method of claim 1, wherein (b) further comprising normalizing the plurality of scores and (c) further comprising generating the plurality of candidate recipes based at least on the normalized scores.

13. The method of claim 1, wherein the optimal predictive model is selected from among the plurality of machine-learning models by performing a sweep across multiple machine-learning models to identify a model that has a lowest median absolute error (MdAE) on a validation dataset.

14. The method of claim 1, wherein the plurality of candidate recipes comprise at least 10,000 candidate recipes.

15. The method of claim 1, wherein the plurality of candidate recipes comprise at least 100,000 candidate recipes.

16. The method of claim 1, wherein the plurality of machine-learning models comprise one or more linear or regression models.

17. The method of claim 1, wherein the plurality of machine-learning models comprise adaboost, random forest, decision tree, support vector, or a neural network.

18. The method of claim 1, wherein the model selector comprises a grid search algorithm, and the selected optimal predictive model comprises a neural network.

19. The method of claim 1, wherein the plurality of machine-learning models comprise a natural language processing (NLP) model.

20. The method of claim 19, wherein the NLP model processes the comments in the feedback data.

21. The method of claim 20, wherein the objective function comprises one or more NLP-derived metrics.

22. The method of claim 1, wherein the selected optimal predictive model predicts individual contributions or effects of each ingredient, as well as its interactions with other ingredients, to or on the plurality of attributes.

23. The method of claim 22, wherein the interactions comprise non-linearities or non-linear behavior or characteristics.

24. The method of claim 1, wherein the initial and the one or more subsequent experimental runs are run over a period of multiple days, weeks or months.

25. The method of claim 1, wherein the one or more subsequent experimental runs comprise one or more modifications to one or more prior candidate recipes.

26. The method of claim 1, wherein the one or more recipe constraints comprise a threshold amount of the one or more of ingredients within the food product.

27. The method of claim 1, wherein the one or more recipe constraints comprise a maximum amount of lipids and proteins.

28. The method of claim 1, wherein the vector for each candidate recipe comprises a floating-point vector such that ingredients in the candidate recipe add up to 100%.

29. The method of claim 1, wherein the objective function maximizes predicted scores for at least one of (1) likeability for each individual attribute, (2) overall likeability, or (3) similarity to the control sample.

30. The method of claim 1, wherein the recipe optimization employs an exploration and exploitation technique.

31. The method of claim 30, wherein (c) and (d) correspond to an exploration phase of the recipe optimization, and (e) and (f) correspond to an exploitation phase of the recipe optimization.

32. The method of claim 31, wherein the exploration phase and the exploitation phase are each adjustable for an n^{th} experimental run, wherein n is an integer greater than 2.

33. The method of claim 32, wherein a number of candidate exploration recipes or samples used in the exploration phase and a number of candidate exploitation recipes or samples used in the exploitation phase are each adjustable from 0% to 100% relative to each other in each experimental run.

34. The method of claim 1, wherein the model selector is trained and retrained by grid sweeping across the multiple machine-learning models for each experimental run.

35. The method of claim 34, wherein data from each experimental run is divided into a training dataset, a validation dataset, and a test dataset.

36. The method of claim 35, wherein the training dataset comprises 50% to 98% of the data, the validation dataset comprises 1% to 25% of the data, and the training dataset comprises 1% to 25% of the data.

37. The method of claim 1, further comprising: formulating hypotheses on ingredients, recipes and food sciences based at least on (1) the one or more top-ranked candidate recipes or other newly generated top-ranked candidate recipes and (2) the feedback data.

38. The method of claim 37, further comprising: providing an interface for facilitating human-machine collaboration, wherein the interface provides graphical and numerical predictions of individual attribute levels and overall likeability levels, in response to one or more new hypotheses that are input by one or more users via the interface.

39. The method of claim 38, wherein the interface comprises color representations or a color scale that is indicative of the predicted individual attribute levels and/or predicted overall likeability levels.

40. The method of claim 1, wherein the plurality of candidate recipes comprise two or more levels of inclusion of each ingredient.

41. The method of claim 1, wherein the seed dataset comprises about 10 to 20 seed recipes.

42. The method of claim 1, wherein the seed dataset comprises no more than about 20 seed recipes.

43. The method of claim 1, wherein the objective function further optimizes a nutritional profile.

44. The method of claim 43, wherein the objective function comprises a similarity metric of the nutritional profile based on quantification of amino acid profile against a target nutritional profile in a naturally occurring product.

45. The method of claim 1, wherein the objective function further optimizes for cooking experience and appearance of the food products during their preparation.

46. The method of claim 1, wherein the food product(s) comprise one or more food scrambles.
